(19) United States
(12) Patent Application Publication
(10) Pub. No.: US 2014/0167748 A1
(43) Pub. Date: Jun. 19, 2014

(54) TUBING PROBE BOBBIN WITH PETAL

(71) Applicant: GENERAL ELECTRIC COMPANY, Schenectady, NY (US)

(72) Inventor: Jae Young Choi, Murrysville, PA (US)

(73) Assignee: GENERAL ELECTRIC COMPANY, Schenectady, NY (US)

(21) Appl. No.: 13/719,289

(22) Filed: Dec. 19, 2012

(51) Int. Cl. G01N 27/90

(52) U.S. Cl. CPC G01N 27/9006
USPC 324/238

(57) ABSTRACT

An apparatus and method for inspecting an elongate tubular member with an eddy current sensor inspection assembly including a bobbin is provided. The bobbin includes a shell defining a hollow interior and axially aligned openings at each end while supporting a sensor. A plurality of petals extend outwardly from the shell, and the petals are configured to position the bobbin concentrically within a tubular member as the bobbin is moved within the tubular member. The bobbin can be included in an inspection assembly with a probe head to support a sensor including at least one wire winding. A flexible shaft is connected to the probe head and transmits a motive force to move the probe head within the tubular member. The probe head includes a flexible tube, the bobbin supporting the sensor, and at least one centering bead mounted upon the flexible tube.

### BACKGROUND OF THE INVENTION

1. Field of the Invention

The present invention relates to internal inspection probes for inspecting tubular members, such as tubular members present within steam power plants.

2. Discussion of Prior Art

Use of inspection/detection devices, such as eddy current sensors, is known. Such devices can be used, for example, for tubular members with bends (e.g., U-bends or other bends which can be considered to provide some amount of a tortuous typically used for steam in power plants. Such power plants may be nuclear or fossil fuel based.

Such known inspection/detection devices are inserted into the tubular members via elongated members. Also, centering feet are associated with the eddy current sensors along the elongated members. It is possible that such known inspection/detection devices have a relatively high degree flexibility between centering feet and the eddy current sensor such that the sensor can be located off-center relative to the tubular member in which it is inserted. Non-concentric positioning of the sensor during tubular member inspection can lead to voltage variation that can exceed acceptable limits and thus incorrect readings. Accordingly, additional inspection testing may be required. Thus, there is a need for improvements to avoid such issues.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides a bobbin for an eddy current sensor including a shell defining a hollow interior and axially aligned openings at each end. The shell is configured to support a sensor. The bobbin further includes a plurality of petals surrounding the shell. The petals extend outwardly from the shell, and the petals are configured to position the bobbin concentrically within an elongate tubular member as the bobbin is moved internally within the elongate tubular member.

Another aspect of the invention provides an inspection assembly for insertion inspection of an elongate tubular member. The inspection assembly includes a probe head including a bobbin. The bobbin includes a shell defining a hollow interior and axially aligned openings at each end and a plurality of petals surrounding the shell. The petals extend outwardly from the shell, and the petals are configured to position the bobbin concentrically within an elongate tubular member as the bobbin is moved internally within the elongate tubular member. The bobbin also includes at least one sensor for sensing a characteristic of the elongate tubular member as the probe head is moved internally within the elongate tubular member. The sensor includes at least one wire winding. The inspection assembly further includes a flexible shaft connected to the probe head that transmits a motive force to the probe head to move the probe head within the elongate tubular member. The probe head includes a flexible tube, the bobbin supporting the sensor and mounted upon the flexible tube, and at least one centering bead mounted upon the flexible tube.

Another aspect of the invention provides a method of inspecting an elongate tubular member. The method further includes the step of providing an inspection assembly for insertion inspection of the elongate tubular member. The inspection assembly includes a probe head including a bobbin. The bobbin includes a shell defining a hollow interior and axially aligned openings at each end and a plurality of petals surrounding the shell. The petals extend outwardly from the shell, and the petals are configured to position the bobbin concentrically within an elongate tubular member as the bobbin is moved internally within the elongate tubular member. The bobbin also includes at least one sensor for sensing a characteristic of the elongate tubular member as the probe head is moved internally within the elongate tubular member. The sensor includes at least one wire winding. The inspection assembly further includes a flexible shaft connected to the probe head that transmits a motive force to the probe head to move the probe head within the elongate tubular member. The probe head includes a flexible tube, the bobbin supporting the sensor and mounted upon the flexible tube, and at least one centering bead mounted upon the flexible tube. The method further includes the step of positioning the bobbin concentrically within the elongate tubular member by compression force of the plurality of petals acting against the inside diameter of the elongate tubular member. The method still further includes the step of moving the probe head within the elongate tubular member. The method also includes the step of sensing a characteristic of the elongate tubular member.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized illustration of an example inspection assembly including an example bobbin in accordance with at least one an aspect of the present invention;

FIG. 2 is an illustration of examplary tubular members conducting steam in a power plant and that have at least one bend and within which the present invention may be utilized;

FIG. 3 is an illustration of torn-away portions of the inspection assembly of FIG. 1 that are within example torn-open portions of a tubular member of the power plant of FIG. 2 and in accordance with at least one aspect of the present invention;

FIG. 4 is an enlarged view of a probe head of the inspection assembly of FIG. 1, and shows an exploded connection to a probe shaft of the inspection assembly;

FIG. 5 is an exploded view of a portion of the probe head of FIG. 4 and shows a two-part bobbin construction that has a hollow interior and providing direct connection of wires directly to a sensor on the bobbin;

FIG. 6 is an enlarged view of certain parts of the probe head of FIG. 4 and shows the interior of the body, with windings thereon and the direct connection of wires for location within the interior;

FIG. 7 is an schematized illustration of an example inspection assembly including an example bobbin and centering feet in accordance with another aspect of the present invention; and

FIG. 8 is a top level flow diagram of an example method of inspecting an elongate tubular member.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

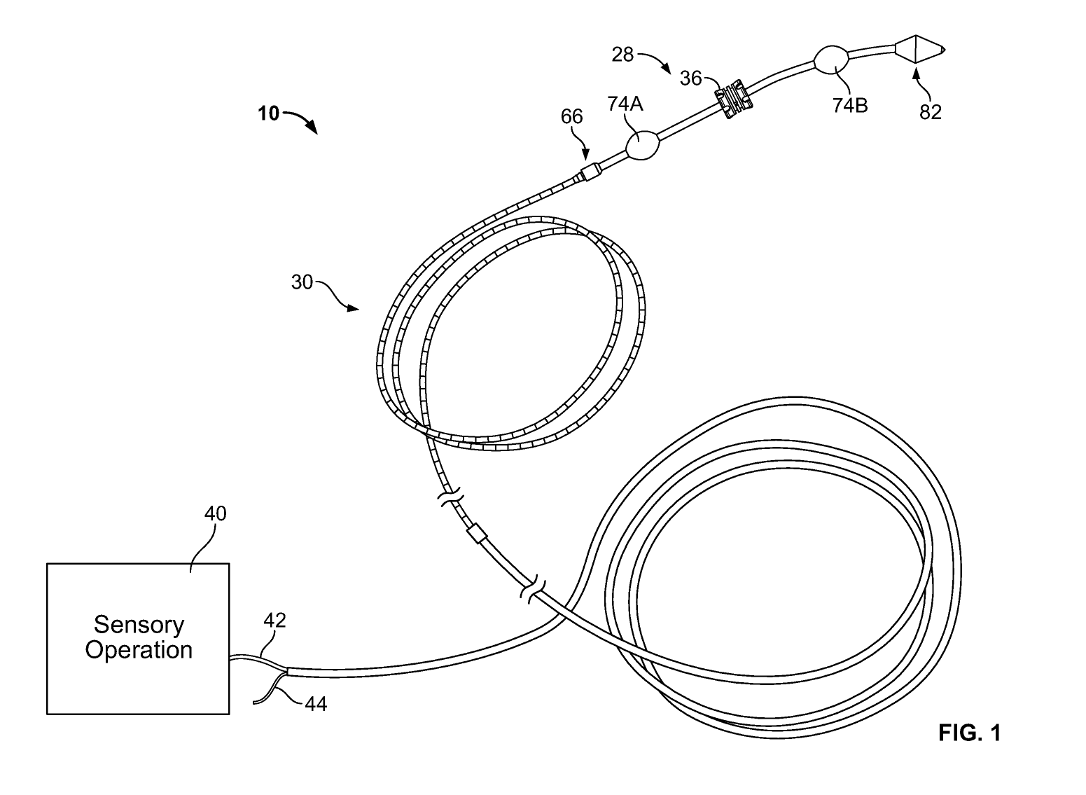

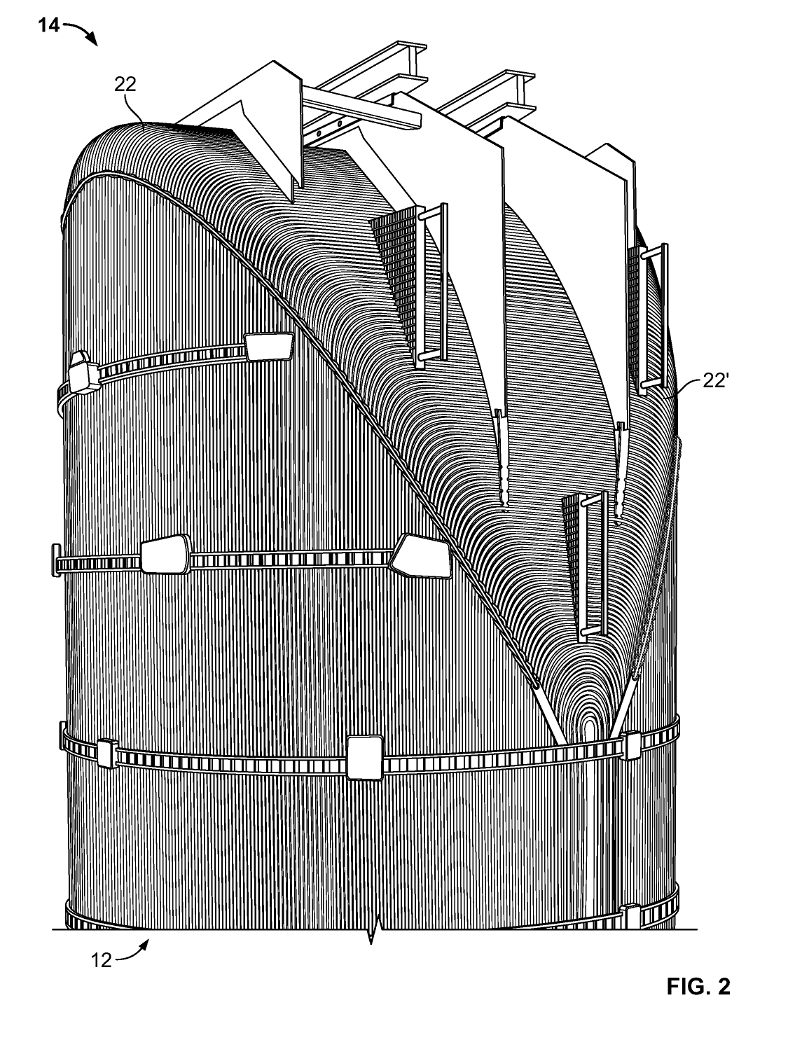

An example of an inspection assembly 10 in accordance with aspects of the present invention is schematically shown in FIG. 1. It is to be appreciated that the example is for illustrative purposes only and need not present specific limitations upon the scope of the present disclosure. The inspection assembly 10 is for insertion inspection of an elongate tubular member 12 (see for example, a tubular member shown within FIG. 2).

Turning briefly to FIG. 2 and the example tubular member 12 shown therein, the device shown in FIG. 2 is an example power plant 14 within which the inspection assembly 10 of FIG. 1 may be utilized. The tubular member 12 may be part of a “Low Row” (50.8 mm (2.0-in) center radius tube and greater) U-bend tube of the power plant 14. The tubular member 12 may also be part of a U-bend tube of the power plant 14 having center bend radii of less than 50.8 mm (2.0-in). The example power plant 14 shown within FIG. 2 merely presents one example environment for the inspection assembly 10. It is to be appreciated that the present invention can be used in other environments (e.g., other tubular environments associated with different power plants and other tubular environments that are not part of a power plant). The power plant 14 and numerous tubular members 12 (only one example tubular member 12 is identified with a reference number, however, any of the shown tubular members could be so identified).

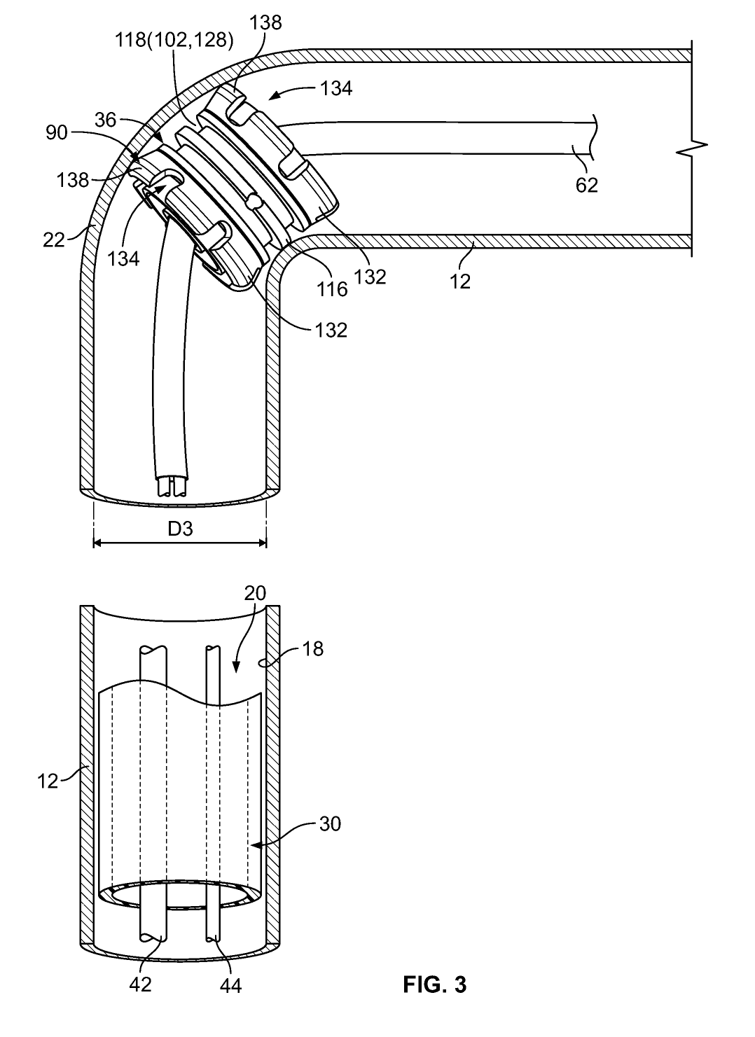

The tubular member 12 is hollow and has a generally arcuate/rounded (e.g., circular or oval cross-section) interior surface 18 (see the example section of FIG. 3). The interior surface 18 of the tubular member 12 bounds an interior space 20 of the tubular member 12. In some specific examples, the tubular member 12 is relatively long and has at least one bend 22 (the example bend shown in FIG. 3 is a transition between vertical and horizontal sections of the tubular member). In further specific examples, the tubular member 12 has multiple bends (e.g., 22′ shown within FIG. 2) and thus provides at least some amount of a tortuous path along its interior space 20. In at least one example, two bends 22, 22′ within the tubular member 12 provides the member with a U-bend configuration. The tubular member 12 can have a varied length. The at least one bend 22 and/or the length of the tubular member 12 can provide for a path within the tubular member 12 that can be considered to be at least somewhat tortuous.

Returning to FIG. 1, the inspection assembly 10 is for inspecting the tubular member 12 (FIGS. 2 and 3) from the inside of the tubular member 12. Such inspection may be in the form of sensing/testing/monitoring at least one condition of the tubular member 12 from the interior space 20 of the tubular member 12 along the tubular member 12. The at least one condition need not be a specific limitation upon the present invention. The inspection assembly 10 as shown in FIG. 1 includes a probe head 28 and a flexible probe shaft 30, with the probe head 28 connected to the probe shaft 30.

At least one sensor 36 (shown generically in FIG. 1) that senses/tests/monitors the at least one characteristic (e.g., a condition) of the tubular member 12 is located within/at the probe head 28. An example of characteristic (e.g., a condition) to be sensed/tested/monitored includes structural integrity (e.g., weakened portions) of the tubular member 12. Details of the presented example probe head 28 are presented below.

The probe head 28 is operatively connected to a sensory operation portion 40 (schematically represented as simply a box) of the inspection assembly 10 via at least one wire 42 (FIG. 3). To be clear, the wire(s) 42 may be a plurality of wires or provided as a wiring bundle and referred to as simply a wire. Different wires within the plurality or bundle could accomplish different functions. The wire(s) 42 extends to be operatively connected to the probe head 28, extends along the length of the probe shaft 30, and extends to be operatively connected to the sensory operation portion 40. The wire(s) 42 are housed within an interior of the probe shaft 30 as described further following. Electrical power and/or electrical signals (e.g., control and/or sensory) are passed along the wire(s) 42 between the probe head 28 and the sensory operation portion 40.

In general, the probe head 28 of the inspection assembly 10 is moved along the interior space 20 of the tubular member 12 while the probe head 28 senses/tests/monitors. The sensory operation portion 40, via the wire connection to the probe head 28, provides power and/or control and receives sensory signals from the probe head 28 to make determination(s) about the sensed/tested/monitored at least one condition of the tubular member 12 as the probe head 28 is moved relatively along the tubular member. In is to be appreciated that the sensory operation portion 40 may contain any suitable structures to perform the functions, such as power source components, processing components (e.g., one or more microprocessors), data storage components, and communication components. The sensory operation portion 40 may be operatively connected to one or more external or intermediary components (not shown) for control of the sensory operation portion 40 and/or provision of the sensory information outside of the shown system and/or other operations.

As mentioned, the probe head 28, with its sensor(s) 36, is moved along the interior of the tubular member 12. The movement along the tubular member 12 is first inbound (e.g., inserting) relative to the tubular member 12 and is secondly outbound (e.g., extracting) relative to the tubular shaft. The motive force to move the probe head 28 along tubular member 12 is imparted via force applied to the probe shaft 30. In one example, the motive force is in the form of manual force applied to the probe shaft 30.

The probe shaft 30, with the included wire(s) 42 and cable 44, is flexible. The flexibility allows the probe shaft 30 to proceed along bends (e.g., 22, 22′) of the tubular member 12. Yet the probe shaft 30 has sufficient rigidity to allow insertion into the tubular member 12 and move the probe head 28 along the extent of the tubular member 12. The overall length of the probe shaft 30 may be any suitable length. However, within one example the length is sufficiently long to meet or exceed a length measured along the entire elongate extent of the tubular member 12. For such an example, the probe head 28 may be moved along the entire elongate extent of the tubular member 12 via insertion movement of the probe shaft 30 into the tubular member 12. In another example, the probe head 28 may be moved along only a portion of the elongate extent of the tubular member 12, removed, and inserted from the opposite end to complete the operation on the remainder of the extent of the tubular member 12. Recall that it is force applied to the probe shaft 30 that moves the probe head 28 along the insertion direction of the tubular member. It should be noted that the probe shaft 30 may include various features and such features need not be part of the present invention.

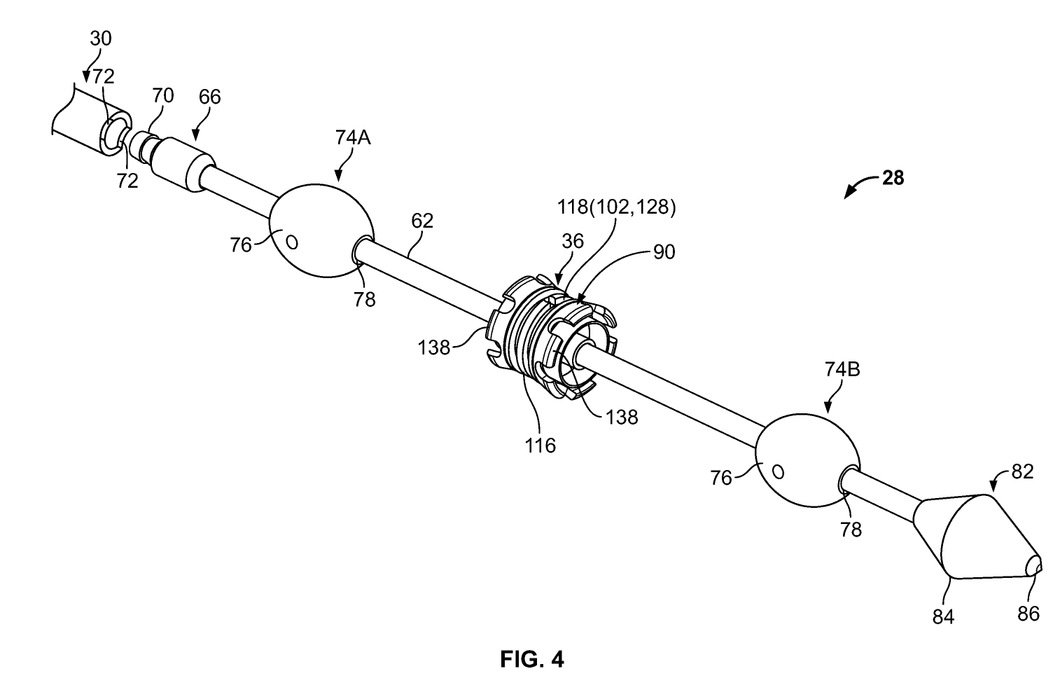

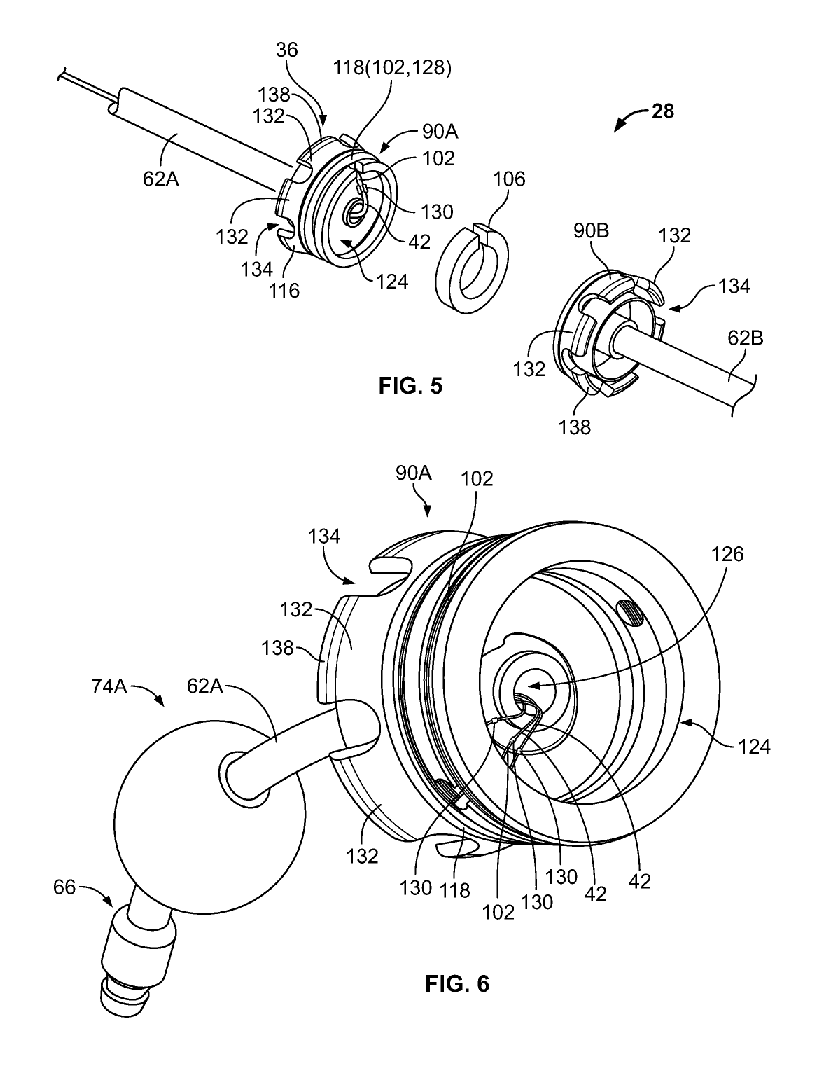

Focusing upon the example probe head shown in FIG. 4, the probe head 28 includes a flexible tube 62. The tube 62 may be made of any suitable flexible material. Some example materials include polymer materials (e.g., flexible polyurethane). The tube 62 is hollow to allow the wire(s) 42 extending within the probe shaft 30 to also extend within the tube 62. The tube 62 actually has two separate segments 62A, 62B (see FIG. 5) that are each joined to the sensor 36. However, for ease of reference, the tube segments are referred to as simply a tube 62.

As mentioned, the probe shaft 30 is attached to the probe head 28. In the shown example, the probe shaft 30 is connected to the tube 62. Specifically, a junction fitting 66 (See FIG. 4 in which the probe shaft 30 is shifted over or exploded from the junction fitting 66 to show more of the junction fitting). In one example, the junction fitting 66 includes a stainless steel ferrule. The junction fitting 66 may be secured to the tube 62 of the probe head 28 via any suitable means (e.g., crimping). With regard to securing the junction fitting 66 to the probe shaft 30, the example shows that the junction fitting 66 has at least one annular barb 70 on an end that extends into the interior of the probe shaft 30. The barb 70 “bites” into the material of the probe shaft 30 at the interior surface of the probe shaft 30 and helps hold the probe shaft 30 onto the junction fitting 66. Also note that within the shown example, two half-moon shapes 72 are provided (e.g., cut or otherwise formed) into the end of the probe shaft 30. Adhesive (e.g., epoxy) is used to bond the probe shaft 30 onto the junction fitting 66 and thus to the probe head 28. The adhesive (e.g., epoxy) can fill the half-moon shapes 72 and can provide for improved bonds to the junction fitting 66 and locking the probe shaft 30 in place relative to the probe head 28. The junction fitting 66 has an interior bore or passage to permit the wire 42 to extend from the probe shaft 30 and into the tube 62 of the probe head 28. In one embodiment, the junction fitting 66 has a minimized diameter to help reduce resistance to movement of the probe shaft 30 and probe head 28 within the tubular member 12.

Turning again to the probe head 28 (FIGS. 1 and 4), the probe head 28 includes at least one centering bead 74A, 74B affixed to the tube 62. Within the shown example, two centering beads 74A, 74B are provided and the two beads are spaced away from each other along the tube 62. The beads 74A, 74B provide a centering function and are generally sized to have a diameter somewhat smaller than an interior of the tube being inspected. The first centering bead 74A may be located a short distance from the junction fitting 66 and may be located on a first side of the sensor 36. The second centering bead 74B may be located on an opposite side of the sensor 36 from the first centering bead 74A. Each centering bead 74A, 74B has a smoothly-curving, arcuate outer surface 76 that is generally rounded. Within the specific shown example, the outer surface 76 is an oblong shape and somewhat egg-shaped with an elongation. The elongation is along the extent of the tube 62 and the amount of elongation can be varied. Each centering bead 74A, 74B has a center passageway 78 through which the tube 62 extends. Each centering bead 74A, 74B may be made of a variety of materials, and the shown example beads are made of a polymer based material (e.g., plastic material—ULTEM®).

At a tip of the probe head 28 is a nose piece 82 that provides a guiding function. The nose piece 82 has an opening into which the tube 62 extends. A widest portion of the nose piece 82 is at a middle region 84 of the nose piece. From the middle region 84, the nose piece tapers radially inward toward a furthest-most tip portion 86 and as such has a first conic taper. Also, from the middle region 84 the nose piece 82 tapers radially inward as the nose piece extends rearward. Thus, the nose piece 82 has a double conic taper. The nose piece 82 may be made of a variety of materials, and the shown example nose piece is made of a polymer based material (e.g., plastic material—ULTEM®).

Focusing now upon the sensor 36, the shown example sensor 36 is an eddy current sensor that includes a bobbin 90 attached to the flexible tube 62. The bobbin is configured to support the sensor 36. The sensor 36 can include at least one wire winding 102. It is to be noted that the wire windings 102 are visible in FIG. 6 and the ends are visible in FIG. 5, however, the windings 102 are omitted in the other Figures. FIGS. 3-5 include reference numeral 102, in parenthesis, present to indicate position occupied by the wire windings 102, but for the purpose of illustrating other structures the wire windings have been removed. The windings 102 are supported on the bobbin 90 of the sensor 36 and the sensor 36 also includes a magnet 106 (FIG. 5). It is to be appreciated that the sensor 36 may include a variety of structures, components, features, and the like, which may be in addition and/or different from the shown example. The shown example is described, but with the understanding that modifications are possible within the scope of the invention.

Within the shown example, the bobbin 90 has a shell 116 that has a general cylindrical shape and that includes at least one annular groove 118. The wire windings 102 are located within the annular groove 118, but, as mentioned, the wire windings 102 are omitted from some of the drawing Figures. An interior 124 (FIG. 5) of the bobbin 90 is hollow. The bobbin 90 has an axially-aligned opening 126 (FIG. 6) at each end and the tube 62 extends to the interior 124 of the bobbin via the openings 126. The magnet 106 is located within the hollow interior 124 of the bobbin 90.

The wire winding 102 of the sensor 36 extends about a periphery of the bobbin 90. In the shown example, the wire winding 102 is located within the annular groove 118. The wire winding 102 within the annular groove may be secured in place/protected via the use of potting material 128 (e.g., epoxy overlaying the wire winding 102 within the annular groove 118). Within the drawing FIGS. 4 and 5, the wire winding 102 and the potting material 128 that is present in the annular groove 118 are not shown for clarity. Within the drawing FIGS. 3-5, the reference numerals 102 and 128 are provided in parenthesis to designate the location within the annular groove 118. Only the ends of the wire winding 102 within the interior 124 are shown in FIG. 5. At least one axially aligned opening 126 extends from the exterior of the bobbin 90 to the interior 124 of the bobbin and the ends of the wire winding 102 extend to the interior of the bobbin 90 through the opening 126. The ends of the wire winding 102 have a solder-connection 130 to the ends of the wire 42. Attention is directed to FIG. 6, which shows the wire windings 102 within the annular groove 118 (but without the potting material 128). Also, the presence of the axially aligned opening 126 through the bobbin 90 to the interior 124 can be appreciated by the visibility of the ends of the wire windings 102 extending into the interior 124. It is to be noted that plural wires 42 are shown with a solder connection 130 to plural ends of the wire windings 102. This is merely one example and the numbers may differ, and certainly within the presented scope that the wire may be a plural bundle and there may be plural wire windings 102.

The provision of the bobbin 90 as a first joinable bobbin piece 90A and a second joinable bobbin piece 90B, and thus the accessibility of the interior 124 of the hollow bobbin 90, allows direct access to the ends of the wire winding 102 and also to the end of the wire 42. In turn, this allows direct electrical connection (e.g., solder connection 130) between the wire winding 102 and the wire 42 (e.g., no intermediary wires or connections are needed). Sensory signals can proceed from the wire winding 102 directly to the wire 42 and in due course to the sensory operation portion 40. The access into the hollow interior 124 and thus the direct electrical connection helps to minimize electrical interference noise by reducing the number of solder junctions. Also, the access into the hollow interior 124 and thus the direct electrical connection allows for the usage of a relatively small diameter for the bobbin 90 and/or the tube 62.

When the joinable bobbin pieces 90A, 90B are adhered together, all of the remaining space within the hollow interior 124 of the bobbin 90 that is not otherwise occupied can be filled-up with adhesive (or other material). Such filling can add strength and can help keep the wire ends (i.e., ends of the wire winding 102 and the wire 42) from moving and shifting, which helps reduce noise and extend probe life.

Within the shown example, the shell 116 includes a plurality of petals 132 surrounding the shell 116 and extending outwardly from the shell 116. In one particular example, the petals 132 are attached to the shell 116 near the annular groove 118 and then extend longitudinally toward one of the ends of the bobbin 90. Individual petals 132 can be arranged circumferentially around the shell 116 with open notches 134 being present between adjacent petals 132. This particular configuration of petals 132 surrounding the bobbin 90 can be said to resemble a crown, particularly when viewing a single one of the joinable bobbin pieces 90A, 90B. It is to be appreciated that this particular configuration of petals 132 is for illustrative purposes only and need not present specific limitations upon the scope of the present disclosure. For example, the petals 132 can simply extend radially from the shell 116. In yet another example, there can be at least two sets of petals arranged circumferentially around the shell 116. In a further example, the petals 132 can be curved structures that extend outwardly from the shell 116 and then return toward the shell 116 or even reconnect with the shell 116. In yet another example, the petals 132 can extend outwardly at an oblique angle from the shell 116.

Regardless of the particular configuration of the petals 132 extending outwardly from the shell 116, the petals 132 are configured to position the bobbin 90 concentrically within an elongate tubular member 12 as the bobbin 90 is moved internally within the elongate tubular member 12. Returning to FIG. 3, the petals 132 extend outwardly to contact the interior surface 18 of the elongate tubular member 12. The plurality of petals 132 arranged circumferentially around the shell 116 will tend to return the bobbin 90 to a position concentric to the elongate tubular member 12 should it move off-center relative to the elongate tubular member 12. In order to foster contact between the petals 132 and the interior surface 18 of the elongate tubular member 12, the greatest diameter of the petals 132 can be slightly larger than the inside diameter of the interior surface 18 of the elongate tubular member 12. In one particular example, the greatest diameter of the petals 132 (when not located within the elongate tubular member 12) can be about 2.54 mm (0.1 in) greater than the inside diameter of the interior surface 18 of the elongate tubular member 12. Thus, when the bobbin 90 is concentric within the elongate tubular member 12, each petal 132 will be deflected about 1.27 mm (0.05 in). It is to be appreciated that a suitable greatest diameter of the petals 132 can be selected to interact with the interior surface 18 of the elongate tubular member 12, and that different diameters of petals can be used with elongate tubular members 12 having different inside diameters D3. It is to be appreciated that other structures, (e.g., bead halves) could be employed.

Other features of the petals 132 can be incorporated to ease the passage of the bobbin 90 through the elongate tubular member 12. In one example, the petals can include a chamfered surface 138 around their edges to ease insertion of the bobbin 90 into the elongate tubular member 12. As shown in FIGS. 3-6, the chamfered surface 138 can include one or more chamfers or surfaces to minimize resistance and/or friction between the bobbin 90 and the elongate tubular member 12 (best shown in FIG. 3). In another example, the petals 132 can be constructed of a relatively flexible material such as a polymer (e.g., nylon) which has a suitably low coefficient of friction with the interior surface 18 of the elongate tubular member 12 yet has a suitably high enough flexibility to withstand compression within the smaller diameter elongate tubular member 12 without permanent deformation. Another criterion for petal 132 material selection is the strength of the bond that can be developed between the joinable bobbin pieces 90A, 90B. In one example, nylon material exhibits suitable bond strength with a particular adhesive (e.g., epoxy). In a further example, the joinable bobbin pieces 90A, 90B and the petals 132 can be constructed of one unitary piece to promote durability of the bobbin 90 and the petals 132.

It has been determined that as the petals 132 center the bobbin 90 within the elongate tubular member 12, an electrical signal created by the sensor 36 tends to be more reliable. In one example, the sensor 36 is an eddy current sensor supported by the bobbin 90 and moved through elongate tubular members 12 to test the structural integrity of the elongate tubular members 12. The wire winding 102, or coil, of the eddy current sensor is wound around the bobbin 90 within the annular groove 118. Variation of the voltage signal created by the eddy current sensor is a function of the distance from the elongate tubular member 12 to the wire winding 102. Therefore, it is beneficial to urge the bobbin 90 to a concentric position within the elongate tubular member 12 so that the wire winding 102 is similarly concentrically positioned within the elongate tubular member 12 in order to minimize variation of the voltage signal. In one particular example, the petals 132 act to center the bobbin 90 concentrically with respect to the elongate tubular member 12 so that the voltage variation of the eddy current sensor supported by the bobbin 90 is less than about 10%.

It is to be appreciated that arrangements of petals 132 surrounding the shell 116 of the sensor 36 can have a greater likelihood of urging the sensor 36 to a concentric location within the elongate tubular member 12 than previously known probe head 28 designs. This greater likelihood of concentric location helps minimize voltage variation of the eddy current sensor supported by the bobbin 90, thus creating a more reliable and accurate sensor 36 reading.

Some previously known probe head designs include centering feet that are located a distance from the sensor. As the sensor and the centering feet are attached to a tube that is often flexible, interaction between the centering feet and an elongate tubular member can urge the centering feet to a concentric location while not directly urging the sensor to a concentric location. As such, the sensor, located a distance away from the centering feet, often has freedom of movement provided by the flexible tube permitting the sensor to travel through the elongate tubular member moving between any number of non-concentric positions within the elongate tubular member. Movement of the sensor in directions generally perpendicular to the axis of the elongate tubular member increases the voltage variation of the eddy current sensor, giving rise to the need for additional sensing of the elongate tubular member, rejection of the sensor results, or a combination thereof.

However, as in the shown examples, arrangements of petals 132 surrounding the sensor 36, can directly urge the sensor 36 to a substantially concentric location within the elongate tubular member 12 rather than rely on the tube 62 (which is often flexible) to help center the sensor 36. As the sensor 36 is more likely to be in a concentric position with respect to the elongate tubular member 12 with petals 132 surrounding the sensor 36, voltage variation of the eddy current sensor 36 can be significantly minimized. This minimization in voltage variation increases the reliability and accuracy of the sensor 36 readings.

Turning to the movement of the probe head 28 along the tubular member 12, it is to be appreciated that the probe head has several separate features that each aid in such movement with reduced resistance. The two piece bobbin 90 allows the solder connections 130 between the wire 42 and the wire windings 102 inside of the bobbin 90, which helps make the probe head 28 not only mechanically stronger and electrically quieter, but also permits a reduced diameter. The bobbin 90 is a reduced diameter, due in part to the other design features (e.g., direct wire connection). As previously mentioned, the petals 132 can have at least one chamfered end surface 138 which can provide for increased flexibility of the probe head 28 and the tube 62 thereof. The other portions of the probe head 28 also have been designed to aid in flexibility and minimize resistance. For example, the centering beads 74 and the nose piece 92 all have tapering surfaces to aid the components to traverse smaller U-Bend tubing radii.

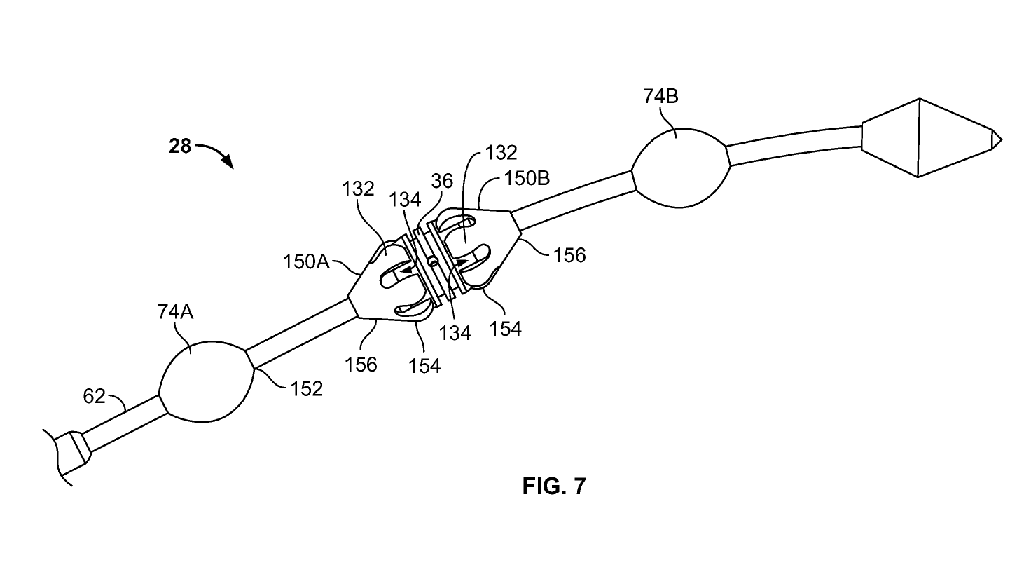

Another aspect of the relationship between the petals 132 and the sensor 36 is shown in FIG. 7. An example probe head 28 can also include at least one centering foot 150 (150A, 150B). Within the shown example, two centering feet 150A, 150B are provided. The centering feet 150A, 150B are spaced away from the centering beads 74A, 74B. Each centering foot 150A, 150B has a general conical shape and a center passageway 152 through which the tube 62 extends. A base or wider portion 154 of each centering foot 150A, 150B faces toward the sensor 36 and the tip or narrower portion 156 of each centering foot 150A, 150B is located distal from the sensor 36. Specifically, each centering foot 150A, 150B can include a cavity at the wider portion 154 which is configured to accept a suitable length of the sensor 36. Thus, the centering feet 150A, 150B are configured to surround at least one portion of the sensor 36.

At the base 156, each centering foot 150A, 150B has a plurality of petals 132 with open notches 134 being present between adjacent petals 132. The centering feet 150A, 150B may be made of a variety of materials, and the shown example feet are made of a polymer based material (e.g., plastic material—Ultem). As described previously, the petals 132 extend outwardly to contact the interior surface 18 of the elongate tubular member 12 (best seen in FIG. 3). A plurality of petals 132 arranged circumferentially around the centering feet 150A, 150B will tend to return the centering feet 150A, 150B to a position concentric to the elongate tubular member 12 should it move off-center relative to the elongate tubular member 12. Because the sensor 36 is at least partially surrounded by each centering foot 150A, 150B, as the centering feet 150A, 150B are urged to the center of the elongate tubular member 12, the sensor 36 is likewise urged to the center of the elongate tubular member 12. In this configuration, any space existing between each centering foot 150A, 150B and the sensor 36 as measured along the tube 62 can be eliminated, thus reducing or eliminating undesired motion of the sensor 36 from a concentric position within the elongate tubular member 12 due to flexibility in the tube 62.

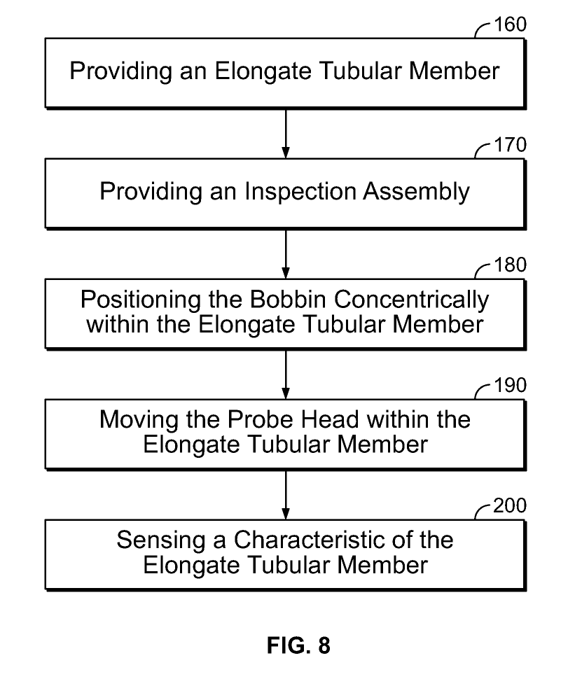

An example method of inspecting an elongate tubular member 12 is generally described in FIG. 8. The method can be performed in connection with the example bobbin 90 and inspection assembly as shown in FIGS. 1 and 3-7. The method includes the step 160 of providing an elongate tubular member 12. The tubular member is hollow and has a generally arcuate/rounded (e.g., circular or oval cross-section) interior surface 18 (see the example section of FIG. 3). The interior surface 18 of the tubular member 12 bounds an interior space 20 of the tubular member 12. In some specific examples the tubular member 12 is relatively long and has at least one bend 22. In further specific examples, the tubular member 12 has multiple bends and thus provides at least a somewhat tortuous path along its interior space 20. In at least one example, two bends 22, 22′ within the tubular member 12 provides the member with a U-bend configuration. The tubular member 12 can have a varied length. The at least one bend 22 and/or the length of the tubular member 12 can provide for a path within the tubular member that can be considered to be at least somewhat tortuous.

The method further includes the step 170 of providing an inspection assembly 10 for insertion inspection of the elongate tubular member 12. The inspection assembly 10 includes a probe head 28 including a bobbin 90. The bobbin 90 includes a shell 116 defining a hollow interior 124 and axially aligned openings 126 at each end and a plurality of petals 132 surrounding the shell 116. The petals 132 extend outwardly from the shell 116 and are configured to position the bobbin 90 concentrically within the elongate tubular member 12 as the bobbin 90 is moved internally within the elongate tubular member 12. The inspection assembly 10 further includes at least one sensor 36 for sensing a characteristic of the elongate tubular member 12 as the probe head 28 is moved internally within the elongate tubular member 12. The sensor 36 includes at least one wire winding 102. The inspection assembly 10 also includes a flexible probe shaft 30 connected to the probe head 28 and transmitting a motive force to the probe head 28 to move the probe head 28 within the elongate tubular member 12. The probe head 28 includes a flexible tube 62, the bobbin 90 supporting the sensor 36 and mounted upon the flexible tube 62, and at least one centering bead 74 mounted upon the flexible tube 62.

The method also includes the step 180 of positioning the bobbin 90 concentrically within the elongate tubular member 12 by radially inward deflection (e.g., radially compressing) of the plurality of petals 132 acting against the inside diameter of the elongate tubular member 12. In one example, the greatest diameter of the petals 132 is larger than the inside diameter of the elongate tubular member 12 so that the petals 132 are at least somewhat compressed or flexed toward the shell 116. Given a suitable spacing of the petals 132 circumferentially around the bobbin 90 and consistent material properties of petal 132, the bobbin 90 will be urged toward a position concentric with the elongate tubular member 12.

The method still further includes the step 190 of moving the probe head 28 within the elongate tubular member 12 and the step 200 of sensing a characteristic of the elongate tubular member 12. At least one sensor 36 (shown generically in FIG. 1) that senses/tests/monitors the at least one characteristic (e.g., a condition) of the tubular member 12 is located within/at the probe head 28. An example of characteristic (e.g., a condition) to be sensed/tested/monitored includes structural integrity (e.g., weakened portions) of the tubular member 12.

In further examples of the method, the petals 132 are arranged circumferentially around the shell 116 with a plurality of open notches 134 between adjacent petals 132. Additionally, the method can include using a bobbin 90 that includes at least two sets of petals 132 arranged circumferentially around the shell 116. The method can also further include using a bobbin 90 having at least two sets of petals 132 arranged circumferentially around the shell 116. In one particular example, each joinable bobbin piece 90A, 90B can have one set of petals 132 arranged circumferentially around their exterior surfaces. In another example of the method, the petals 132 are constructed of a flexible material such as a polymer (e.g., nylon). In yet another example of the method, the step of positioning the bobbin 90 concentrically within the elongate tubular member 12 limits a voltage variation of a sensor signal to less than about 10% during the step of sensing a characteristic of the elongate tubular member 12.

One problem that can be solved via use of the presently described apparatus and methods is possibly eliminating unreliable readings of an eddy current sensor detecting the structural integrity of an elongate tubular member. A particular voltage variation of such readings cannot exceed a prescribed level according to government standards for measurements of some tubular members incorporated in certain power plant equipment such as steam power plants. Such a problem solution may be of particular interest to a utility company that generated electricity via use of a steam power plant as shown in FIG. 2. Specifically, the present invention may be useful for low row tubing examination of a steam power plant. Current technology includes a flexible attachment between the bobbin and centering feet located a distance away from the bobbin. While the centering feet act to keep the bobbin concentrically located within the tubular member, the flexible attachment between the bobbin and the centering feet allows the bobbin to move away from a concentric position, thereby creating voltage variation in the signal read by the sensor. Such previous techniques may be associated with rejected readings and can result in more setup and test time. By developing a bobbin and inspection assembly that urges the bobbin and the sensor to a concentric position within the tubular member, the sensor voltage variation can be significantly decreased. As a result, the utilities will save time, money and radiation exposure.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A bobbin for an eddy current sensor including:
a shell defining a hollow interior and axially aligned openings at each end, the shell configured to support a sensor;
a plurality of petals surrounding the shell, wherein the petals extend outwardly from the shell, the petals configured to position the bobbin concentrically within an elongate tubular member as the bobbin is moved internally within the elongate tubular member.

2. The bobbin according to claim 1, wherein the petals are arranged circumferentially around the shell with a plurality of open notches between adjacent petals.

3. The bobbin according to claim 2, further including at least two sets of petals arranged circumferentially around the shell.

4. The bobbin according to claim 1, wherein the petals are attached to the shell.

5. The bobbin according to claim 1, wherein the petals are attached to a centering foot configured to surround at least one portion of the sensor.

6. The bobbin according to claim 1, wherein the shell further includes a first joinable piece and a second joinable piece.

7. The bobbin according to claim 1, wherein the petals are constructed of a relatively flexible material.

8. An inspection assembly for insertion inspection of an elongate tubular member, the inspection assembly including:
a probe head including a bobbin, the bobbin including:
a shell defining a hollow interior and axially aligned openings at each end;
a plurality of petals surrounding the shell, wherein the petals extend outwardly from the shell, the petals configured to position the bobbin concentrically within an elongate tubular member as the bobbin is moved internally within the elongate tubular member;
at least one sensor for sensing a characteristic of the elongate tubular member as the probe head is moved internally within the elongate tubular member, the sensor including at least one wire winding; and
a flexible shaft connected to the probe head and transmitting a motive force to the probe head to move the probe head within the elongate tubular member,
wherein the probe head includes a flexible tube, the bobbin supporting the sensor and mounted upon the flexible tube, and at least one centering bead mounted upon the flexible tube.

9. The inspection assembly according to claim 8, wherein the petals are arranged circumferentially around the shell with a plurality of open notches between adjacent petals.

10. The inspection assembly according to claim 9, wherein the bobbin further includes at least two sets of petals arranged circumferentially around the shell.

11. The inspection assembly according to claim 8, wherein the petals are attached to the shell.

12. The inspection assembly according to claim 8, wherein the petals are attached to a centering foot configured to surround at least one portion of the sensor.

13. The inspection assembly according to claim 8, wherein the shell further includes a first joinable piece and a second joinable piece.

14. The inspection assembly according to claim 8, wherein the petals are constructed of a relatively flexible material.

15. A method of inspecting an elongate tubular member including:
providing an inspection assembly for insertion inspection of the elongate tubular member, the inspection assembly including:
a probe head including a bobbin, the bobbin including:
a shell defining a hollow interior and axially aligned openings at each end;
a plurality of petals surrounding the shell, wherein the petals extend outwardly from the shell, the petals configured to position the bobbin concentrically within an elongate tubular member as the bobbin is moved internally within the elongate tubular member;
at least one sensor for sensing a characteristic of the elongate tubular member as the probe head is moved internally within the elongate tubular member, the sensor including at least one wire winding;
a flexible shaft connected to the probe head and transmitting a motive force to the probe head to move the probe head within the elongate tubular member,
wherein the probe head includes a flexible tube, the bobbin supporting the sensor and mounted upon the flexible tube, and at least one centering bead mounted upon the flexible tube;
positioning the bobbin concentrically within the elongate tubular member by compression force of the plurality of petals acting against the inside diameter of the elongate tubular member;
moving the probe head within the elongate tubular member; and
sensing a characteristic of the elongate tubular member.

16. The method according to claim 15, wherein the petals are arranged circumferentially around the shell with a plurality of open notches between adjacent petals.

17. The method according to claim 16, wherein the bobbin includes at least two sets of petals arranged circumferentially around the shell.

18. The method according to claim 15, wherein the shell further includes a first joinable piece and a second joinable piece.

19. The method according to claim 15, wherein the petals are constructed of a relatively flexible material.

20. The method according to claim 15, wherein the step of positioning the bobbin concentrically within the elongate tubular member limits a voltage variation of a sensor signal to less than about 10% during the step of sensing a characteristic of the elongate tubular member.
